(19) United States
(12) Patent Application Publication
(10) Pub. No.: US 2021/0048543 A1
(43) Pub. Date: Feb. 18, 2021

(54) X-RAY DETECTOR COVER AND X-RAY DETECTOR HAVING SAME

(71) Applicant: VIEWORKS CO., LTD., Anyang-si (KR)

(72) Inventor: In Dong KIM, Yongin-si (KR)

(73) Assignee: VIEWORKS CO., LTD., Anyang-si (KR)

(21) Appl. No.: 16/988,381

(22) Filed: Aug. 7, 2020

(30) Foreign Application Priority Data
Aug. 13, 2019 (KR) 10-2019-0099051
Jul. 29, 2020 (KR) 10-2020-0094524

(51) Int. Cl. G01T 1/20

(52) U.S. Cl. CPC G01T 1/20188

(57) ABSTRACT

Disclosed are an X-ray detector cover and an X-ray detector including the same. The X-ray detector cover according to the exemplary embodiment of the present invention includes a core having a single-layered structure, a first reinforcing panel joined to one surface of the core, a second reinforcing panel joined to the other surface of the core, and a conductive thin plate joined to one surface of the second reinforcing panel.

### CROSS-REFERENCE TO RELATED APPLICATIONS

This application claims priority to and the benefit of Korean Patent Application No. 10-2019-0099051 filed in the Korean Intellectual Property Office on Aug. 13, 2019 and Korean Patent Application No. 10-2020-0094524 filed in the Korean Intellectual Property Office on Jul. 29, 2020, the entire contents of which are incorporated herein by reference.

### TECHNICAL FIELD

The present invention relates to an X-ray detector cover mounted on an X-ray detector, and more particularly, to an X-ray detector cover having a sandwich structure that provides sufficient strength and is advantageous in reducing a weight of an apparatus, and to an X-ray detector having the same.

### BACKGROUND ART

In general, an X-ray imaging system broadly includes an X-ray generator and an X-ray detector. The X-ray generator generates X-rays and emits the generated X-rays toward a test object on the X-ray detector, and the X-ray detector obtains image data by converting light (visible light), which is generated in response to the X-rays transmitted through the test object, into an electrical (electric charge) signal.

The X-ray detector of the X-ray imaging system generally includes an image sensor unit, an electronic circuit board, and an automatic exposure requesting signal generator. The image sensor unit includes a scintillator including materials that react with the X-rays transmitted through the test object, and an image detecting part configured to detect light (visible light) generated by the scintillator. The image sensor unit further includes a gate driving part, a read-out part, and the like.

The scintillator includes fluorescent materials that react with the X-rays transmitted through the test object to generate the light (visible light) as described above. The scintillator converts the X-rays, which are emitted from the X-ray generator and transmitted through the test object, into the light (visible light). The image detecting part obtains image data by converting the light (visible light), which is converted by the scintillator, into an electrical signal.

The image detecting part is generally called a photoelectric conversion panel, converts the light (visible light), which is converted by the scintillator, into the electrical signal, and outputs the electrical signal. The image detecting part generally includes a plurality of pixels arranged in a matrix and charges each of the pixels with electric charges in proportion to the light amount of visible light generated by the scintillator.

Under control of a control unit (not illustrated), the gate drive unit performs an operation of sequentially selecting specific lines of the image detecting part and applying a driving signal. The read-out unit serves to read out values of the electric charges stored in each of the pixels on the corresponding line when the driving signal is applied to the specific line of the image detecting part by the gate drive unit.

The X-ray detector includes a cover. Based on a propagation direction of the X-rays emitted from the X-ray generator, the cover is disposed in front of the image sensor unit so as to be spaced, at a predetermined gap, apart from the image sensor unit including the scintillator and the image detecting part (the photoelectric conversion panel). The cover serves to cover the image sensor unit, thereby protecting the image sensor unit and supporting the test object.

Therefore, the cover needs to have durability enough for the cover to withstand impact or loads without being damaged or plastically deformed even though a considerable level of external impact or load is applied. In addition, since the cover is disposed in front of the image sensor unit based on the propagation direction of the X-rays, the cover needs to completely transmit the X-rays toward the image sensor unit without distorting the X-rays.

The cover applied to the X-ray detector in the related art is mostly made of a single material such as carbon fiber reinforced plastic (hereinafter, referred to as ‘CFRP’ for convenience). The reason why the CFRP is used as the material of the cover is that because of the material property of the CFRP, the CFRP may transmit the X-rays while having a significantly higher level of strength in comparison with other composite resin when the thickness remains the same.

However, if the cover is made of only by CFRP, there is a limitation in maintaining appropriate strength and reducing a weight because of the material property. Therefore, there is a problem in that it is not easy to respond to the need for a reduction in weight of the X-ray detector in this field. If carbon fibers are not uniformly distributed throughout a thickness direction, there may occur a deterioration in image quality, such as non-uniform patterns on the captured image.

### SUMMARY OF THE INVENTION

The present invention has been made in an effort to provide an X-ray detector cover which has a sandwich structure in which a lightweight material such as polyethylene terephthalate (PET) foam is used as an intermediate material, such that the X-ray detector cover may meet the need for a reduction in weight of an X-ray detector while having strength enough to satisfy a load bearing condition required by the X-ray detector, and an X-ray detector including the same.

The present invention has also been made in an effort to provide an X-ray detector cover, in which the amount of CFRP may be reduced by the amount by which a lightweight material such as PET foam is used as an intermediate material, such that costs may be reduced, and a problem of an image defect may be solved, and an X-ray detector including the same.

An X-ray detector cover according to an exemplary embodiment of the present invention includes a core having a single-layered structure, a first reinforcing panel joined to one surface of the core, a second reinforcing panel joined to the other surface of the core, and a conductive thin plate joined to one surface of the second reinforcing panel.

Particularly, the first reinforcing panel, the second reinforcing panel, and the core may be made of a composite resin material capable of transmitting an X-ray, and the first reinforcing panel and the second reinforcing panel may be equal in thickness to the core or have a thinner thickness than the core and the first reinforcing panel and the second reinforcing panel may be equal in thickness to the conductive thin plate or have a thicker thickness than the conductive thin plate.

Particularly, the core may be made of PET foam, and the first reinforcing panel and the second reinforcing panel may be made of CFRP.

Particularly, the X-ray detector cover may further include a rim reinforcing part disposed on the same plane as the core so as to surround the core.

Particularly, the rim reinforcing part may be disposed between the first reinforcing panel and the second reinforcing panel and equal in thickness to the core.

Particularly, the rim reinforcing part may be joined to the core outside a region in which the X-ray is transmitted.

Particularly, a hole into which a fastening member is inserted may be formed to penetrate the first reinforcing panel, the rim reinforcing part, the second reinforcing panel, and the conductive thin plate.

Particularly, a stepped portion on which a head of the fastening member is seated may be formed in a partial region of the rim reinforcing part.

An X-ray detector cover according to another exemplary embodiment of the present invention includes: a core having a multilayer sandwich structure; a first reinforcing panel joined to one surface of the core; a second reinforcing panel joined to the other surface of the core; and a conductive thin plate joined to one surface of the second reinforcing panel, in which the core includes a plurality of core layers formed as multiple layers, and one reinforcing panel is disposed between the adjacent core layers.

Particularly, the first reinforcing panel, the second reinforcing panel, and the core may be made of a composite resin material capable of transmitting an X-ray, and the first reinforcing panel and the second reinforcing panel may be equal in thickness to the core layers or have a thinner thickness than the core layers the first reinforcing panel and the second reinforcing panel may be equal in thickness to the conductive thin plate or have a thicker thickness than the conductive thin plate.

Particularly, the core may include: a first core layer having one surface to which the first reinforcing panel is joined; and a second core layer having one surface to which the second reinforcing panel is joined, and a third reinforcing panel may be formed between the first core layer and the second core layer.

Particularly, the first core layer and the second core layer, which constitute the core, may be made of PET foam, and the first reinforcing panel, the second reinforcing panel, and the third reinforcing panel may be made of CFRP.

Particularly, the first reinforcing panel, the second reinforcing panel, and the third reinforcing panel may be equal in thickness to the first core layer and the second core layer or have a thinner thickness than the first core layer and the second core layer.

Particularly, the X-ray detector cover may further include: a rim reinforcing part having a multilayer structure and disposed between the first reinforcing panel and the second reinforcing panel, in which the rim reinforcing part includes: a first reinforcing layer disposed on the same plane as the first core layer so as to surround the first core layer; and a second reinforcing layer disposed on the same plane as the second core layer so as to surround the second core layer, and the third reinforcing panel may be disposed between the first reinforcing layer and the second reinforcing layer.

Particularly, the first reinforcing layer may be equal in thickness to the first core layer, and the second reinforcing layer may be equal in thickness to the second core layer.

Particularly, the first reinforcing layer may be joined to the first core layer outside a region in which the X-ray is transmitted, and the second reinforcing layer may be joined to the second core layer outside a region in which the X-ray is transmitted.

An X-ray detector according to still another exemplary embodiment of the present invention includes: a casing having a housing structure opened at one side thereof; an X-ray detector cover coupled to the casing; a board unit supported and spaced apart from a back plate by a board seating protrusion of an upper surface of the back plate that constitutes the casing; a panel unit disposed between the X-ray detector cover and the board unit and configured to obtain an image information from an X-ray transmitted through the X-ray detector cover; and a spacer disposed between the panel unit and the board unit.

Particularly, the X-ray detector cover may include: a core; a first reinforcing panel joined to one surface of the core; a second reinforcing panel joined to the other surface of the core; and a conductive thin plate joined to one surface of the second reinforcing panel.

Particularly, the first reinforcing panel, the second reinforcing panel, and the core may be made of a composite resin material capable of transmitting the X-ray, the core may be made of PET foam, and the first reinforcing panel and the second reinforcing panel may be made of CFRP.

Particularly, the X-ray detector may further include: a rim reinforcing part disposed on the same plane as the core so as to surround the core, in which the rim reinforcing part is disposed between the first reinforcing panel and the second reinforcing panel.

Particularly, the rim reinforcing part may be joined to the core outside a region in which the X-ray is transmitted.

Particularly, a hole into which a fastening member is inserted may be formed to penetrate the first reinforcing panel, the rim reinforcing part, the second reinforcing panel, and the conductive thin plate, and a part of an edge of the X-ray detector cover is fixed by the fastening member through the hole to an assembling stepped portion formed on the casing.

Particularly, the spacer may be made of EPP.

The X-ray detector cover according to the exemplary embodiment of the present invention has the sandwich structure in which the lightweight material such as PET foam having a predetermined thickness is used as the intermediate material, such that strength may be maintained as it is, an overall weight may be greatly reduced, and costs may be reduced in comparison with the configuration in the related art in which the single CFRP material is used.

The CFRP having a relatively thin thickness is disposed at the upper and lower sides of the core made of PET foam used as the intermediate material, such that the CFRP pattern is decreased when transmitting the X-rays, and as a result, a problem of image quality in the related art, which is caused by a deviation in distribution of carbon fibers, may be greatly solved.

In the case of the exemplary embodiment in which the core has the multilayer sandwich structure, a thickness of the CFRP disposed at the upper and lower sides of the core is further decreased, and additional CFRP, which has the same thickness as the CFRP disposed at the upper and lower sides of the core, is disposed in a middle portion of the core, such that an overall thickness of the CFRP may be decreased, and an overall weight of the X-ray detector may be further decreased because of a dispersion effect of the CFRP.

In the case of the exemplary embodiment in which a single layer or multiple layers of CFRP are disposed at the edge of the X-ray detector cover so as to surround the outer surface of the core, the layers in the core in the vicinity of the bolt may not be separated when the X-ray detector is dropped or when lateral impact is applied to the X-ray detector.

In the case of the X-ray detector to which the X-ray detector cover according to the exemplary embodiment of the present invention is applied, the spacer and the board unit are coupled to each other so that a part of the board unit (or the entire board unit) is received in the board receiving portion of the spacer, such that an overall thickness of the panel assembly may be thin, and thus the apparatus may become slim.

In the case of the X-ray detector to which the traction bar is applied, the spacer may be stably disposed in the casing without fixing the spacer to the casing by using a separate fixing device or component, such that an assembly process may be shortened because no separate fixing device or component is required, and as a result, there is an advantageous effect in terms of productivity.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of an X-ray detector to which an X-ray detector cover according to an exemplary embodiment of the present invention is applied.

FIG. 2 is an exploded perspective view of a panel assembly illustrated in FIG. 1.

FIG. 3 is a schematic cross-sectional view illustrating a main part in a state in which the X-ray detector illustrated in FIG. 1 is coupled.

FIG. 4 is a schematic cross-sectional view illustrating a first exemplary embodiment of the X-ray detector cover illustrated in FIG. 3.

FIG. 5 is a schematic cross-sectional view illustrating a state in which the X-ray detector cover according to the first exemplary embodiment is coupled (an enlarged view of part A in FIG. 3).

FIG. 6 is an exploded perspective view of the X-ray detector cover illustrated in FIG. 4.

FIG. 7 is a schematic cross-sectional view illustrating a second exemplary embodiment of the X-ray detector cover illustrated in FIG. 3.

FIG. 8 is an exploded perspective view of the X-ray detector cover illustrated in FIG. 7.

FIG. 9 is a schematic cross-sectional view illustrating a third exemplary embodiment of the X-ray detector cover illustrated in FIG. 3.

FIG. 10 is a schematic cross-sectional view illustrating a fourth exemplary embodiment of the X-ray detector cover illustrated in FIG. 3.

FIG. 11 is a schematic cross-sectional view illustrating a main part in a state in which the X-ray detector according to another exemplary embodiment is coupled.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

The terminology used in the present specification is used for the purpose of describing particular exemplary embodiments only and is not intended to limit the present invention. Singular expressions include plural expressions unless clearly described as different meanings in the context. In the present specification, the terms “comprises,” “comprising,” “includes,” “including,” “containing,” “has,” “having” or other variations thereof are inclusive and therefore specify the presence of stated features, integers, steps, operations, elements, components, and/or combinations thereof, but do not preclude the presence or addition of one or more other features, integers, steps, operations, elements, components, and/or combinations thereof.

The terms such as “first” and “second” may be used to describe various constituent elements, but the constituent elements should not be limited by the terms. These terms are used only to distinguish one constituent element from another constituent element.

The term “unit”, “part”, “module”, or the like, which is described in the specification, means a unit that performs at least one function or operation, and the “unit”, “part”, “module”, or the like may be implemented by hardware, software, or a combination of hardware and software.

In the description of the exemplary embodiments with reference to the accompanying drawings, the same constituent elements will be designated by the same reference numerals, and the repetitive description thereof will be omitted. Further, in the description of the present invention, the specific descriptions of publicly-known related technologies will be omitted when it is determined that the specific descriptions may unnecessarily obscure the subject matter of the present invention.

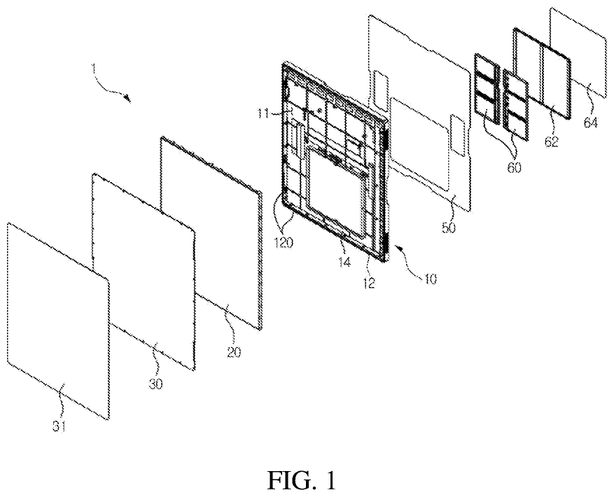

Hereinafter, an X-ray detector cover 30 and an X-ray detector 1 including the X-ray detector cover 30 according to an exemplary embodiment of the present invention will be described with reference to FIGS. 1 to 11.

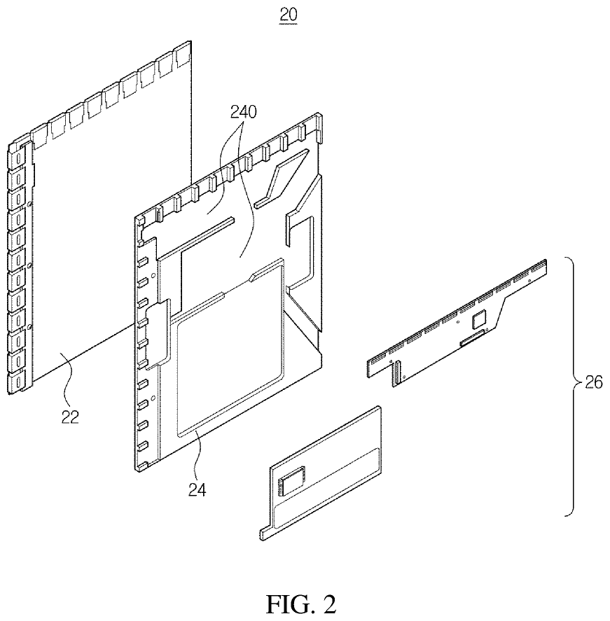

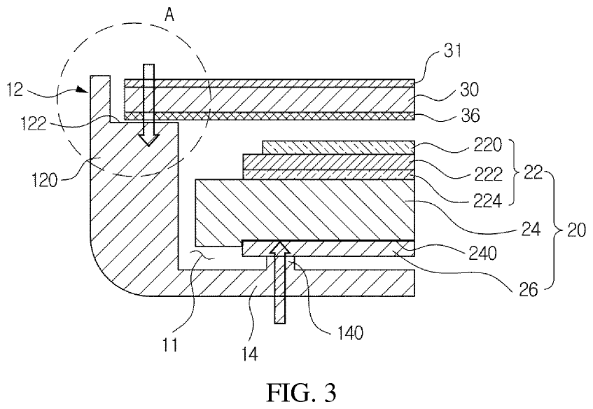

FIG. 1 is an exploded perspective view of the X-ray detector 1 to which the X-ray detector cover 30 according to the exemplary embodiment of the present invention is applied, and FIG. 2 is an exploded perspective view of a panel assembly 20 illustrated in FIG. 1. Further, FIG. 3 is a schematic cross-sectional view illustrating a main part in a state in which the X-ray detector 1 illustrated in FIG. 1 is coupled.

Referring to FIGS. 1 to 3, the X-ray detector 1 refers to a device that obtains image data by converting light (visible light), which is emitted from a phosphor that reacts with X-rays transmitted through a test object (not illustrated), into an electrical (electric charge) signal. The X-ray detector 1 includes a casing 10 having a structure in the form of a housing (e.g., a rectangular box) opened at one side thereof. A component mounting space 11 is formed inside the casing 10, and the panel assembly 20 is installed in the component mounting space 11.

The casing 10 may include a frame 12 having a plurality of lateral supports 120, and a back plate 14 installed to adjoin a lower end of each of the lateral supports 120 of the frame 12 and configured to define a bottom surface of the casing 10. In the exemplary embodiment of the present invention, the plurality of lateral supports 120 may define a lateral surface of the casing 10.

The X-ray detector cover 30 is installed at the opened side of the casing 10, and the panel assembly 20 may be disposed between the X-ray detector cover 30 and the back plate 14. As an example, the detector cover 30 may have a structure in the form of a rectangular and flat plate. However, the structure of the detector cover 30 is not limited to a rectangular structure but may be variously modified to be a curved structure or the like.

Referring to FIG. 1, a rear finishing panel 50 may be attached to a rear surface of the casing 10, and a battery 60, which stores electrical energy to be supplied to a board unit 26 to be described below, may be mounted in a battery mounting space (not illustrated) defined in the casing 10.

In addition, the X-ray detector 1 further includes a battery cover 62 configured to cover the battery mounting space, and a finishing film 64 attached to an externally exposed surface of the battery cover 62.

As illustrated in FIGS. 2 and 3, the panel assembly 20 includes a board unit 26 disposed adjacent to the back plate 14, and a panel unit 22 disposed relatively distant from the back plate 14. In addition, the panel assembly 20 may have a spacer 24 interposed between the board unit 26 and the panel unit 22 to maintain a gap between the board unit 26 and the panel unit 22. The board unit 26 produces a control signal by receiving an electrical signal transmitted from the outside, and the panel unit 22 may operate based on the produced control signal.

The panel unit 22 may have a scintillator 220, a photoelectric conversion panel 222, and a radiation shielding plate 224 disposed below the photoelectric conversion panel 222. As an example, the radiation shielding plate 224 may be made of lead (Pb).

The scintillator 220 has fluorescent materials that emit light (visible light) by reacting with the X-rays transmitted through the test object. The photoelectric conversion panel 222 may convert the light (visible light), which is generated by the scintillator 220, into an electrical (electric charge) signal and output the electrical signal.

The photoelectric conversion panel 222 includes photoelectric conversion elements (not illustrated) arranged in a photodiode-based matrix, and a switch element (not illustrated) configured to control electrical conduction between the photoelectric conversion elements. As an example, the switch element includes a thin film transistor (TFT).

When the board unit 26 operates, a drive chip mounted on the board unit 26 sequentially selects specific lines of the photoelectric conversion panel 222 and applies a driving signal. When the driving signal is applied, image information may be produced based on an electric charge value of the photoelectric conversion element in the corresponding line.

As illustrated in FIG. 3, the board unit 26 may be supported and spaced apart from the back plate 14 by a board seating protrusion 140 of an upper surface of the back plate 14 that constitutes the casing 10.

Particularly, the board unit 26 may be stably fixed, without swaying, onto the board seating protrusion 140 by a fastening member (not illustrated) which is inserted from a lower surface of the back plate 14 of the casing 10 and fastened to the board seating protrusion 140. As an example, the fastening member may be a bolt.

The panel unit 22 is seated on an upper surface of the spacer 24 which is interposed between the board unit 26 and the panel unit 22 to maintain the gap between the board unit 26 and the panel unit 22. The board unit 26 may be in close contact with a lower surface of the spacer 24. In this case, as illustrated in FIGS. 2 and 3, a board receiving portion 240, which has a predetermined size and a predetermined depth corresponding to a shape of the board unit 26, may be recessed into the surface of the spacer 24 (e.g., the lower surface of the spacer 24) which faces the board unit 26.

A part or the entirety of the board unit 26 is received in the board receiving portion 240, such that the spacer 24 and the board unit 26 may be coupled to each other in a state in which the board unit 26 is inserted into the spacer 24. Therefore, the spacer 24 may be stably fixed in the casing 10 without swaying. In addition, since a part or the entirety of the board unit 26 is received in the board receiving portion 240, an overall thickness of the panel assembly 20 is decreased to the extent to which the board unit 26 is received in the board receiving portion 240, thereby making the apparatus slimmer.

As an example, the spacer 24 may be made of a material capable of stably supporting the panel unit 22, having sufficient resistance to heat generated from the board unit 26, and satisfying a reduction in weight of the apparatus. Particularly, the spacer 24 may be made of expanded polypropylene (EPP) in the form of spherical particles formed by physically foaming polypropylene without using a chemical foaming agent, or made of PET foam which is saturated polyester resin obtained by synthesizing terephthalic acid and ethylene glycol. The spacer 24 may have a thickness of about 1.5 to 9.5 mm.

The X-ray detector 1 according to the exemplary embodiment of the present invention includes the X-ray detector cover 30. Referring to FIG. 1, the X-ray detector cover 30 is disposed to be spaced apart from a front side (upper side) of the panel unit 22 of the panel assembly 20 at a predetermined interval based on a propagation direction of X-rays emitted from an X-ray generator (not illustrated). The X-ray detector cover 30 serves to cover the panel unit 22, thereby protecting the panel unit 22 from the outside and supporting the test object.

The X-ray detector cover 30 may be coupled to an open end of the casing 10 by the lateral supports 120. As illustrated in FIG. 3, the X-ray detector cover 30 may be coupled to the casing 10 in a state in which a part of an edge of the X-ray detector cover 30 is seated and fixed to an assembling stepped portion 122 formed inside an upper end of the lateral support 120. As an example, the X-ray detector cover 30 may be securely fixed to the assembling stepped portion 122 by means of a fastening member (a bolt or the like).

The X-ray detector cover 30 needs to have durability enough for the X-ray detector cover 30 to withstand impact or loads without being damaged or plastically deformed even though a considerable level of external impact or load is applied. In addition, since the X-ray detector cover 30 is disposed in front of the panel unit 22, which is an image sensor unit, based on the propagation direction of the X-rays, the X-ray detector cover 30 needs to completely transmit the X-rays toward the panel unit 22 without distorting the X-rays.

Meanwhile, if the cover is made of only by CFRP like the technology in the related art, there is a limitation in maintaining appropriate strength and reducing a weight because of the material property. Therefore, there is a problem in that it is not easy to respond to the need in the market for a reduction in weight of the X-ray detector. If carbon fibers are not uniformly distributed throughout a thickness direction, there may occur a deterioration in image quality, such as non-uniform patterns on the captured image.

The X-ray detector cover 30, which is applied to the X-ray detector 1 according to the present invention, uses a lightweight material, such as PET foam which is a saturated polyester resin obtained by synthesizing terephthalic acid and ethylene glycol, as an intermediate material. The X-ray detector cover 30 may have a sandwich structure in which CFRP having a relatively thin thickness is disposed at upper and lower sides of the intermediate material. Therefore, the X-ray detector cover 30 may meet the need of reducing weight while having strength enough to satisfy a load bearing condition required by the X-ray detector 1.

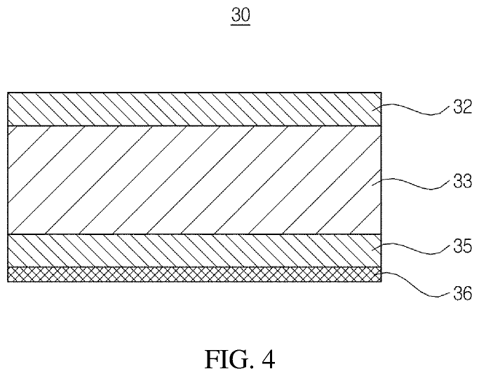

Hereinafter, a first exemplary embodiment of the X-ray detector cover 30 having the sandwich structure applied to the X-ray detector 1 according to the present invention will be described in more detail with reference to FIGS. 4 to 6.

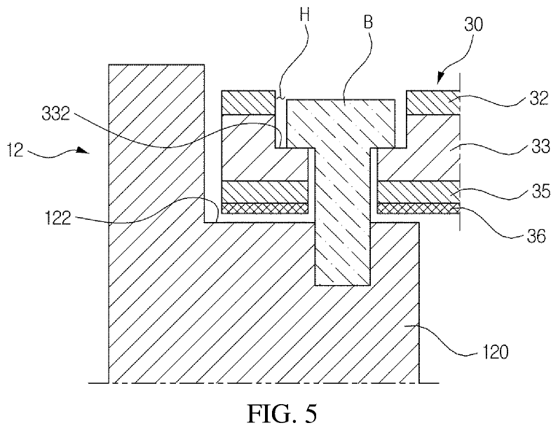

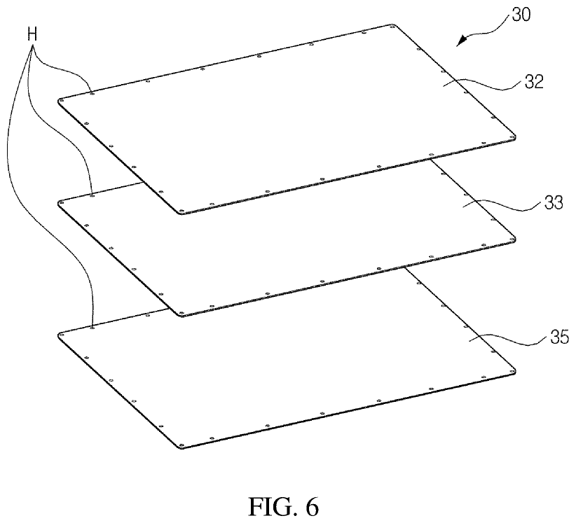

FIG. 4 is a schematic cross-sectional view illustrating the first exemplary embodiment of the X-ray detector cover 30 illustrated in FIG. 3, FIG. 5 is a schematic cross-sectional view illustrating a state in which the X-ray detector cover 30 according to the first exemplary embodiment is coupled (an enlarged view of part A in FIG. 3), and FIG. 6 is an exploded perspective view of the X-ray detector cover 30 illustrated in FIG. 4. A front finishing panel 31 to be described below is omitted from FIG. 5, and a conductive thin plate 36 to be described below is omitted from FIG. 6.

Referring to FIGS. 4 to 6, the X-ray detector cover 30 according to the first exemplary embodiment of the present invention includes a core 33 having a single-layered structure, and a first reinforcing panel 32 joined to one surface (an upper surface) of the core 33. In addition, the X-ray detector cover 30 has a second reinforcing panel 35 joined to the other surface (a lower surface) of the core 33, and the conductive thin plate 36 for reducing an image noise which is joined to one surface (a lower surface) of the second reinforcing panel 35 in a direction toward the lower surface of the core 33.

As illustrated in FIGS. 3 and 4, the front finishing panel 31 may be stacked on and coupled to a surface (an upper surface of the first reinforcing panel 32) opposite to the surface of the first reinforcing panel 32 which is joined to the core 33. The front finishing panel 31 receives the X-rays emitted from the X-ray generator, and the received X-rays are transmitted through the first reinforcing panel 32, the core 33, and the second reinforcing panel 35 and introduced into the panel assembly 20, particularly, the panel unit 22, such that the X-rays may be converted into an electrical signal.

In the exemplary embodiment of the present invention, the X-ray detector cover 30 may be made of a composite resin material capable of transmitting the X-rays so that the X-rays emitted from the front finishing panel 31 are transmitted through the first reinforcing panel 32, the core 33, and the second reinforcing panel 35 and introduced into the panel unit 22.

Particularly, the first reinforcing panel 32 and the second reinforcing panel 35 may have a thinner thickness than the core 33. As an example, the first reinforcing panel 32 and the second reinforcing panel 35 may have the same thickness as the core 33 or be thinner than the core 33 and the first reinforcing panel 32 and the second reinforcing panel 35 may be thicker than the conductive thin plate 36 or have the same thickness as the conductive thin plate 36.

The core 33, which is the intermediate material in the X-ray detector cover 30 according to the first exemplary embodiment of the present invention, may be made of PET foam having a thickness of 0.4 to 1.0 mm. The first reinforcing panel 32 joined to one surface of the core 33 and the second reinforcing panel 35 joined to the other surface of the core 33 may be made of CFRP having a thickness of 0.4 to 0.5 mm.

The conductive thin plate 36, which is provided to reduce an image noise, is a thin plate-shaped body having electrical conductivity and may be configured by vapor-depositing or applying an electrically conductive material onto a surface of the plate-shaped body made of a nonmetal material or a metal material having conductivity. In this case, the conductive thin plate 36 may be an aluminum thin plate when the conductive thin plate 36 is made of a metal material, but the material of the conductive thin plate 36 is not limited to aluminum as long as the material is a metal material having conductivity.

Referring to FIGS. 5 and 6, the X-ray detector cover 30 according to the first exemplary embodiment of the present invention is configured by sequentially stacking the first reinforcing panel 32, the core 33, the second reinforcing panel 35, and the conductive thin plate 36. Thereafter, holes H are formed in an edge portion of the X-ray detector cover 30 through post-processing so as to penetrate the first reinforcing panel 32, the core 33, the second reinforcing panel 35, and the conductive thin plate 36, and fastening members (e.g., bolts B or the like) are inserted into the holes H, such that the X-ray detector cover 30 may be coupled to the casing 10. In this case, although not illustrated, the bolt B may be inserted into the casing 10 through the hole H by penetrating an insertion hole formed in the front finishing panel 31.

In more detail, the X-ray detector cover 30 may be fixed to the assembling stepped portion 122 formed inside the upper end of the lateral support 120 as the bolt B passes through the X-ray detector cover 30 through the hole H in a state in which a part of the edge of the X-ray detector cover 30 is positioned on the assembling stepped portion 122. In this case, an insertion hole into which the bolt B may be inserted may also be formed in the assembling stepped portion 122.

As illustrated in FIG. 5, when forming the hole H in the edge portion of the X-ray detector cover 30, a stepped portion 332 on which a head of the bolt B is seated may be formed in a partial region of the core 33. In this case, since the head of the bolt B is seated on the stepped portion 332, the X-ray detector cover 30 and the casing 10 may be more stably coupled when a threaded portion of the bolt B is inserted into the assembling stepped portion 122 while penetrating the hole H.

Meanwhile, although not illustrated in FIG. 5, in a case in which a thickness of the head of the bolt B is thinner than a thickness of the first reinforcing panel 32, the stepped portion may be formed in a partial region of the first reinforcing panel 32, and the head of the bolt B may be seated on the stepped portion.

With the above-mentioned configuration, the X-ray detector cover 30 may be coupled to the casing 10 in the state in which a part of the edge is seated and fixed onto the assembling stepped portion 122.

As described above, the X-ray detector cover 30 according to the first exemplary embodiment of the present invention may use the lightweight material such as PET foam having a predetermined thickness as the intermediate material, thereby reducing an overall weight of the X-ray detector 1 and reducing costs. In addition, the CFRP having a relatively thin thickness is disposed at the upper and lower sides of the intermediate material, such that the CFRP pattern is decreased when transmitting the X-rays, and as a result, a problem of image quality in the related art, which is caused by a deviation in distribution of carbon fibers, may be greatly solved.

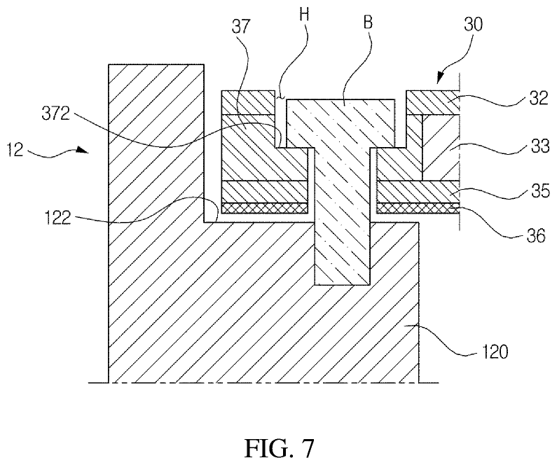

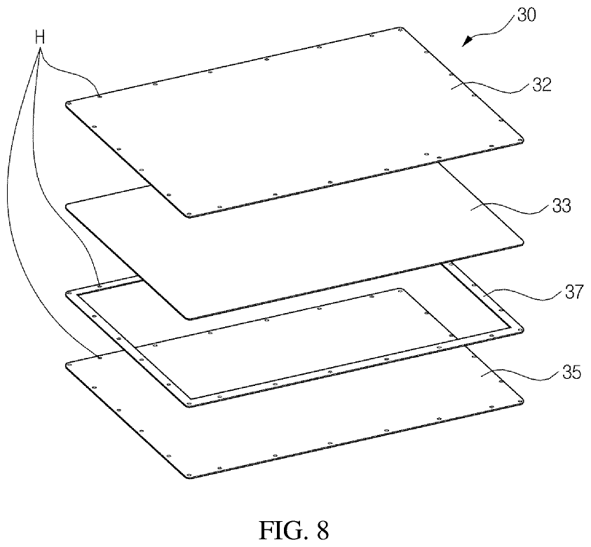

FIG. 7 is a schematic cross-sectional view illustrating a second exemplary embodiment of the X-ray detector cover 30 illustrated in FIG. 3, and FIG. 8 is an exploded perspective view of the X-ray detector cover 30 illustrated in FIG. 7. The front finishing panel 31 is omitted from FIG. 7, and the conductive thin plate 36 is omitted from FIG. 8.

In the second exemplary embodiment illustrated in FIGS. 7 and 8, the X-ray detector cover 30 is not greatly different from the X-ray detector cover 30 described in the first exemplary embodiment except that a rim reinforcing part 37 in the form of a picture frame is additionally provided around an outer surface of the core 33. Therefore, hereinafter, only the additional configuration will be described, and the repetitive description of the other configurations identical to the configurations described in the first exemplary embodiment will be omitted.

The X-ray detector cover 30 described in the first exemplary embodiment may use a lightweight material such as PET foam as the intermediate material, thereby reducing an overall weight of the X-ray detector 1, reducing the CFRP pattern when transmitting the X-rays, and thus improving image quality.

Although the joining force between the core 33 made of PET foam and the first and second reinforcing panels 32 and 35 made of CFRP is good, coupling force between layers in the PET foam is relatively low, and as a result, there may be a problem in that the layers in the PET foam are separated when the X-ray detector 1 is dropped or when lateral impact is applied to the X-ray detector 1.

In order to solve the problem, as illustrated in FIGS. 7 and 8, the X-ray detector cover 30 according to the second exemplary embodiment may further include the rim reinforcing part 37 made of CFRP and disposed on the same plane as the core 33 so as to surround the core 33.

The rim reinforcing part 37 may be disposed between the first reinforcing panel 32 and the second reinforcing panel 35 and formed (in the form of a picture frame) to surround the outer surface of the core 33.

In more detail, as illustrated in FIG. 7, the rim reinforcing part 37 may be positioned on the edge portion of the X-ray detector cover 30, the first reinforcing panel 32 may be joined to one surface (an upper surface) of the rim reinforcing part 37, and the second reinforcing panel 35 may be joined to the other surface (a lower surface) of the rim reinforcing part 37. In this case, the rim reinforcing part 37 may be joined to the outer surface of the core 33 so as to surround the outer surface of the core 33, and the rim reinforcing part 37 may be formed to be equal in thickness to the core 33.

The rim reinforcing part 37 may be joined to the outer surface of the core 33 outside a region in which the X-rays are transmitted, that is, a region in which the first reinforcing panel 32, the core 33, the second reinforcing panel 35, and the conductive thin plate 36 are sequentially stacked.

Meanwhile, although not illustrated in FIGS. 7 and 8, the X-ray detector cover 30 according to the second exemplary embodiment may be configured such that the rim reinforcing part 37 is provided to surround all of the first reinforcing panel 32, the core 33, the second reinforcing panel 35, and the conductive thin plate 36 outside the region in which the first reinforcing panel 32, the core 33, the second reinforcing panel 35, and the conductive thin plate 36 are sequentially stacked. In this case, the rim reinforcing part 37 may be disposed on the same plane as the first reinforcing panel 32, the core 33, the second reinforcing panel 35, and the conductive thin plate 36 so as to surround the outer surfaces of the first reinforcing panel 32, the core 33, the second reinforcing panel 35, and the conductive thin plate 36.

Like the X-ray detector cover 30 according to the first exemplary embodiment, the first reinforcing panel 32, the core 33, the rim reinforcing part 37, the second reinforcing panel 35, and the conductive thin plate 36 are sequentially stacked in the X-ray detector cover 30 according to the second exemplary embodiment, as illustrated in FIGS. 7 and 8. Thereafter, the holes H are formed in the edge portion of the X-ray detector cover 30 through post-processing so as to penetrate the first reinforcing panel 32, the rim reinforcing part 37, the second reinforcing panel 35, and the conductive thin plate 36, and the bolts B are inserted into the holes H, such that the X-ray detector cover 30 may be coupled to the casing 10.

As illustrated in FIG. 7, when forming the hole H in the edge portion of the X-ray detector cover 30, a stepped portion 372 on which the head of the bolt B is seated may be formed in a partial region of the rim reinforcing part 37. In this case, since the head of the bolt B is seated on the stepped portion 372, the X-ray detector cover 30 and the casing 10 may be more stably coupled when a threaded portion of the bolt B is inserted into the assembling stepped portion 122 while penetrating the hole H.

Meanwhile, although not illustrated in FIG. 7, in a case in which a thickness of the head of the bolt B is thinner than a thickness of the first reinforcing panel 32, the stepped portion may be formed in a partial region of the first reinforcing panel 32, and the head of the bolt B may be seated on the stepped portion.

As described above, the X-ray detector cover 30 according to the second exemplary embodiment may further include the rim reinforcing part 37 disposed to surround the outer surface of the core 33, thereby preventing the layers in the core 33 in the vicinity of the bolt B from being separated when the X-ray detector 1 is dropped or when lateral impact is applied to the X-ray detector 1. In addition, the rim reinforcing part 37 may be provided only on the edge portion of the X-ray detector cover 30, thereby minimizing an increase in weight in comparison with the X-ray detector cover 30 according to the first exemplary embodiment.

In the present invention, the X-rays are emitted to the front finishing panel 31, transmitted through the first reinforcing panel 32, the core 33, and the second reinforcing panel 35, and then introduced into the panel unit 22. In this case, the transmittance of the X-rays does not deteriorate regardless of the arrangement of the rim reinforcing part 37 because the rim reinforcing part 37 is provided only on the edge portion of the X-ray detector cover 30 according to the second exemplary embodiment, as illustrated in FIG. 7.

Therefore, in comparison with the X-ray detector cover 30 according to the first exemplary embodiment, the X-ray detector cover 30 according to the second exemplary embodiment may minimize an increase in weight, maintain image quality, and further improve durability (rigidity) of the X-ray detector cover 30.

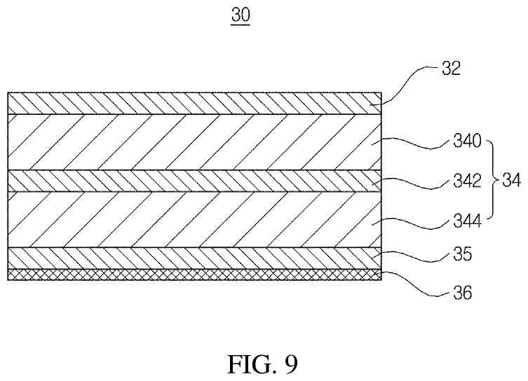

FIG. 9 is a schematic cross-sectional view illustrating a third exemplary embodiment of the X-ray detector cover 30 illustrated in FIG. 3.

The X-ray detector cover 30 according to the third exemplary embodiment illustrated in FIG. 9 is not greatly and structurally different from the X-ray detector cover 30 according to the first exemplary embodiment except that a core 34, which is an intermediate material, has a multilayer sandwich structure. Therefore, hereinafter, only the additional configuration will be described, and the repetitive description of the other configurations identical to the configurations described in the first exemplary embodiment will be omitted.

The X-ray detector cover 30 according to the third exemplary embodiment includes a core 34 and the first reinforcing panel 32 joined to one surface (the upper surface) of the core 34. In addition, the X-ray detector cover 30 has the second reinforcing panel 35 joined to the other surface (the lower surface) of the core 34, and the conductive thin plate 36 for reducing an image noise which is joined to one surface (the lower surface) of the second reinforcing panel 35 in the direction toward the lower surface of the core 34.

The core 34 has the multilayer sandwich structure and includes a first core layer 340 having one surface (an upper surface) to which the first reinforcing panel 32 is joined, and a second core layer 344 having one surface (a lower surface) to which the second reinforcing panel 35 is joined.

The core 34 may have the sandwich structure in which a third reinforcing panel 342 made of CFRP and having a predetermined thickness is formed between the first core layer 340 and the second core layer 344 in order to further enhance overall rigidity of the X-ray detector cover 30.

The first core layer 340 and the second core layer 344, which constitute the core 34, may be made of composite resin, which is light in weight and may transmit the X-rays, particularly, PET foam having a thickness of 0.2 to 0.7 mm. In addition, the first reinforcing panel 32 and the second reinforcing panel 35, which are disposed to face each other with the core 34 interposed therebetween, may be made of CFRP having a thickness of 0.1 to 0.3 mm, and the third reinforcing panel 342 between the first core layer 340 and the second core layer 344 may be made of CFRP having a thickness of 0.1 to 0.3 mm.

As described above, in the X-ray detector cover 30 according to the third exemplary embodiment, the third reinforcing panel 342 made of CFRP is additionally disposed in a middle portion of the core 34, such that overall rigidity of the X-ray detector cover 30 may be further improved.

In comparison with the reinforcing panels of the X-ray detector cover 30 according to the first exemplary embodiment, the thickness of the first reinforcing panel 32 and the thickness of the second reinforcing panel 35 are further decreased, and the third reinforcing panel 342, which is equal in thickness to the first reinforcing panel 32 and the second reinforcing panel 35, is disposed in the middle portion of the core 34, such that an overall thickness of a CFRP layer may be decreased in comparison with the X-ray detector cover 30 according to the first exemplary embodiment, and the X-ray detector 1 may become lighter in weight because of a dispersion effect of the CFRP.

Meanwhile, the multilayer sandwich structure of the core 34 has been described as having the two core layers as illustrated in FIG. 9, but this configuration is just illustrative, and the number of core layers is not necessarily limited to two. Two or more core layers may be provided as multiple layers, and one reinforcing panel may be disposed between the adjacent two core layers.

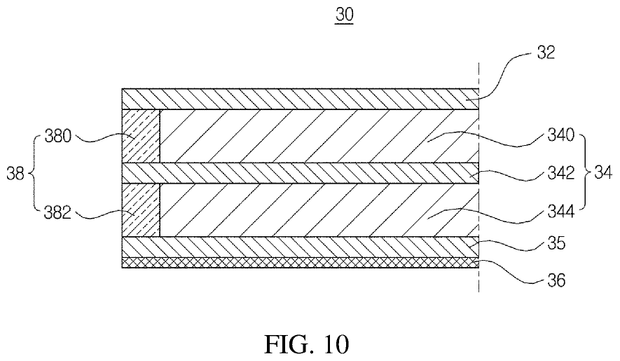

FIG. 10 is a schematic cross-sectional view illustrating a fourth exemplary embodiment of the X-ray detector cover 30 illustrated in FIG. 3. The front finishing panel 31 is omitted from FIG. 10, and only a part of the X-ray detector cover 30 is illustrated unlike the third exemplary embodiment of the X-ray detector cover 30 illustrated in FIG. 9.

The X-ray detector cover 30 according to the fourth exemplary embodiment illustrated in FIG. 10 is not greatly different from the X-ray detector cover 30 described in the third exemplary embodiment except that a rim reinforcing part 38, which is in the form of a multilayer picture frame disposed around the outer surfaces of the first core layer 340 and the second core layer 344, is added to the configuration of the core 34 according to the third exemplary embodiment. Therefore, hereinafter, only the additional configuration will be described, and the repetitive description of the other configurations identical to the configurations described in the third exemplary embodiment will be omitted.

As illustrated in FIG. 10, the X-ray detector cover 30 according to the fourth exemplary embodiment may further include the rim reinforcing part 38 having the multilayer structure disposed between the first reinforcing panel 32 and the second reinforcing panel 35. In this case, the material of the rim reinforcing part 38 may be CFRP.

The rim reinforcing part 38 includes a first reinforcing layer 380 disposed on the same plane as the first core layer 340 so as to surround the first core layer 340, and a second reinforcing layer 382 disposed on the same plane as the second core layer 344 so as to surround the second core layer 344.

The first reinforcing layer 380 may be disposed between the first reinforcing panel 32 and the third reinforcing panel 342 and formed (in the form of a picture frame) to surround the outer surface of the first core layer 340. In addition, the second reinforcing layer 382 may be disposed between the third reinforcing panel 342 and the second reinforcing panel 35 and formed (in the form of a picture frame) to surround the outer surface of the second core layer 344. Further, the third reinforcing panel 342 may be disposed between the first reinforcing layer 380 and the second reinforcing layer 382.

In more detail, as illustrated in FIG. 10, the first reinforcing layer 380 may be positioned on an upper edge portion of the X-ray detector cover 30, the first reinforcing panel 32 may be joined to one surface (an upper surface) of the first reinforcing layer 380, and the third reinforcing panel 342 may be joined to the other surface (a lower surface) of the first reinforcing layer 380. In this case, the first reinforcing layer 380 may be joined to the outer surface of the first core layer 340 so as to surround the outer surface of the first core layer 340, and the first reinforcing layer 380 may be formed to be equal in thickness to the first core layer 340.

Likewise, as illustrated in FIG. 10, the second reinforcing layer 382 may be positioned on a lower edge portion of the X-ray detector cover 30, the third reinforcing panel 342 may be joined to one surface (an upper surface) of the second reinforcing layer 382, and the second reinforcing panel 35 may be joined to the other surface (a lower surface) of the second reinforcing layer 382. In this case, the second reinforcing layer 382 may be joined to the outer surface of the second core layer 344 so as to surround the outer surface of the second core layer 344, and the second reinforcing layer 382 may be formed to be equal in thickness to the second core layer 344.

The first reinforcing layer 380 and the second reinforcing layer 382 may be joined to the outer surface of the first core layer 340 and the outer surface of the second core layer 344, respectively, outside a region in which the X-rays are transmitted, that is, a region in which the first reinforcing panel 32, the first core layer 340, the third reinforcing panel 342, the second core layer 344, the second reinforcing panel 35, and the conductive thin plate 36 are sequentially stacked.

Meanwhile, like the X-ray detector cover 30 according to the second exemplary embodiment, although not illustrated in FIG. 10, the X-ray detector cover 30 according to the fourth exemplary embodiment may be configured such that the rim reinforcing part 38 is provided to surround all of the first reinforcing panel 32, the core 34, the second reinforcing panel 35, and the conductive thin plate 36 outside the region in which the first reinforcing panel 32, the core 34, the second reinforcing panel 35, and the conductive thin plate 36 are sequentially stacked. In this case, the rim reinforcing part 38 may be configured in a single layer and disposed on the same plane as the first reinforcing panel 32, the core 34, the second reinforcing panel 35, and the conductive thin plate 36 so as to surround the outer surfaces of the first reinforcing panel 32, the core 34, the second reinforcing panel 35, and the conductive thin plate 36.

As described above, according to the X-ray detector cover 30 according to the fourth exemplary embodiment, the rim reinforcing part 38, which is disposed to surround the outer surface of the first core layer 340 and the outer surface of the second core layer 344, is added to the configuration of the core 34 according to the third exemplary embodiment, thereby preventing the layers in the first and second core layers 340 and 344 in the vicinity of the bolt from being separated when the X-ray detector 1 is dropped or when lateral impact is applied to the X-ray detector 1. In addition, the rim reinforcing part 38 may be provided only on the edge portion of the X-ray detector cover 30, thereby minimizing an increase in weight in comparison with the X-ray detector cover 30 according to the third exemplary embodiment.

Like the X-ray detector cover 30 according to the third exemplary embodiment, the detector cover 30 according to the fourth exemplary embodiment is configured such that the third reinforcing panel 342 made of CFRP is additionally disposed in the middle portion of the core 34, such that overall rigidity of the X-ray detector cover 30 may be further improved, an overall thickness of the CFRP layer may be decreased in comparison with the X-ray detector cover 30 according to the first exemplary embodiment, and the X-ray detector 1 may become light in weight because of the dispersion effect of the CFRP.

Like the detector cover 30 according to the second exemplary embodiment, the rim reinforcing part 38 of the detector cover 30 according to the fourth exemplary embodiment is provided only on the edge portion of the X-ray detector cover 30, as illustrated in FIG. 10, such that the transmittance of the X-rays does not deteriorate regardless of the arrangement of the rim reinforcing part 38. Therefore, in comparison with the X-ray detector cover 30 according to the third exemplary embodiment, the X-ray detector cover 30 according to the fourth exemplary embodiment may minimize an increase in weight, maintain image quality, and further improve durability (rigidity) of the X-ray detector cover 30.

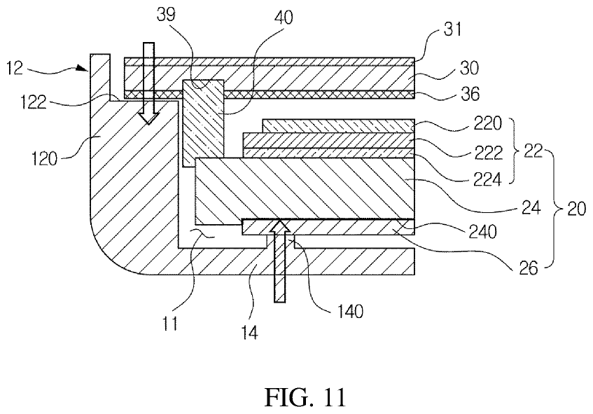

FIG. 11 is a schematic cross-sectional view illustrating a main part in a state in which the X-ray detector 1 according to another exemplary embodiment is coupled.

Hereinafter, in the description with reference to FIG. 11, the constituent elements identical to the constituent elements of the X-ray detector 1 illustrated in FIG. 3 will be designated by the same reference numerals and then described.

As illustrated in FIG. 11, in the present invention, a traction bar 40 having one end attached and fixed to the X-ray detector cover 30 may be used to fix the spacer 24 in a state in which the spacer 24 is pulled toward the X-ray detector cover 30. In this case, a fixing groove 39 having a predetermined depth is formed in a surface of the X-ray detector cover 30 that faces the spacer 24, and a part of the traction bar 40 (one side of the traction bar 40) may be inserted, joined, and fixed into the fixing groove 39.

The other side of the traction bar 40, which is coupled to the spacer 24, may be inserted, joined, and fixed into a fixing groove (not illustrated) formed in the spacer 24. Alternatively, the other side of the traction bar 40 may be configured in the form of a claw coupled to a lateral portion of the spacer 24 to constrain a part of an edge of the spacer 24. In this case, the traction bar 40 may also be made of a lightweight material, particularly, PET foam that may completely transmit the X-rays without distorting the X-rays.

The X-ray detector 1 illustrated in FIG. 11 may stably position the spacer 24 in the casing 10 without fixing the spacer 24 to the casing 10 by using a separate fixing device or component. That is, no separate fixing device or component is required to fix the spacer 24 in the casing 10, such that an assembly process may be shortened, and as a result, there is an advantageous effect in terms of productivity.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An X-ray detector cover comprising:
a core having a single-layered structure;
a first reinforcing panel joined to one surface of the core;
a second reinforcing panel joined to the other surface of the core; and
a conductive thin plate joined to one surface of the second reinforcing panel.

2. The X-ray detector cover of claim 1, wherein the first reinforcing panel, the second reinforcing panel, and the core are made of a composite resin material capable of transmitting an X-ray, and the first reinforcing panel and the second reinforcing panel are equal in thickness to the core or have a thinner thickness than the core and the first reinforcing panel and the second reinforcing panel are equal in thickness to the conductive thin plate or have a thicker thickness than the conductive thin plate.

3. The X-ray detector cover of claim 1, wherein the core is made of PET foam, and the first reinforcing panel and the second reinforcing panel are made of CFRP.

4. The X-ray detector cover of claim 1, further comprising:
a rim reinforcing part disposed on the same plane as the core so as to surround the core.

5. The X-ray detector cover of claim 4, wherein the rim reinforcing part is disposed between the first reinforcing panel and the second reinforcing panel and equal in thickness to the core.

6. The X-ray detector cover of claim 4, wherein the rim reinforcing part is joined to the core outside a region in which the X-ray is transmitted.

7. The X-ray detector cover of claim 4, wherein a hole into which a fastening member is inserted is formed to penetrate the first reinforcing panel, the rim reinforcing part, the second reinforcing panel, and the conductive thin plate.

8. The X-ray detector cover of claim 7, wherein a stepped portion on which a head of the fastening member is seated is formed in a partial region of the rim reinforcing part.

9. An X-ray detector cover comprising:
a core having a multilayer sandwich structure;
a first reinforcing panel joined to one surface of the core;
a second reinforcing panel joined to the other surface of the core; and
a conductive thin plate joined to one surface of the second reinforcing panel,
wherein the core comprises a plurality of core layers formed as multiple layers, and one reinforcing panel is disposed between the adjacent core layers.

10. The X-ray detector cover of claim 9, wherein the first reinforcing panel, the second reinforcing panel, and the core are made of a composite resin material capable of transmitting an X-ray, and the first reinforcing panel and the second reinforcing panel are equal in thickness to the core layers or have a thinner thickness than the core layers and the first reinforcing panel and the second reinforcing panel are equal in thickness to the conductive thin plate or have a thicker thickness than the conductive thin plate.

11. The X-ray detector cover of claim 9, wherein the core comprises:
a first core layer having one surface to which the first reinforcing panel is joined; and
a second core layer having one surface to which the second reinforcing panel is joined, and
wherein a third reinforcing panel is formed between the first core layer and the second core layer.

12. The X-ray detector cover of claim 11, wherein the first core layer and the second core layer, which constitute the core, are made of PET foam, and the first reinforcing panel, the second reinforcing panel, and the third reinforcing panel are made of CFRP.

13. The X-ray detector cover of claim 11, wherein the first reinforcing panel, the second reinforcing panel, and the third reinforcing panel are equal in thickness to the first core layer and the second core layer or have a thinner thickness than the first core layer and the second core layer.

14. The X-ray detector cover of claim 11, further comprising:
a rim reinforcing part having a multilayer structure and disposed between the first reinforcing panel and the second reinforcing panel,
wherein the rim reinforcing part comprises:
a first reinforcing layer disposed on the same plane as the first core layer so as to surround the first core layer; and
a second reinforcing layer disposed on the same plane as the second core layer so as to surround the second core layer, and
wherein the third reinforcing panel is disposed between the first reinforcing layer and the second reinforcing layer.

15. The X-ray detector cover of claim 14, wherein the first reinforcing layer is equal in thickness to the first core layer, and the second reinforcing layer is equal in thickness to the second core layer.

16. The X-ray detector cover of claim 14, wherein the first reinforcing layer is joined to the first core layer outside a region in which the X-ray is transmitted, and the second reinforcing layer is joined to the second core layer outside a region in which the X-ray is transmitted.

17. An X-ray detector comprising:
a casing having a housing structure opened at one side thereof;
an X-ray detector cover coupled to the casing;
a board unit supported and spaced apart from a back plate by a board seating protrusion of an upper surface of the back plate that constitutes the casing;
a panel unit disposed between the X-ray detector cover and the board unit and configured to obtain an image information from an X-ray transmitted through the X-ray detector cover; and
a spacer disposed between the panel unit and the board unit,
wherein the X-ray detector cover comprises:
a core;
a first reinforcing panel joined to one surface of the core;
a second reinforcing panel joined to the other surface of the core; and
a conductive thin plate joined to one surface of the second reinforcing panel.

18. The X-ray detector of claim 17, wherein the first reinforcing panel, the second reinforcing panel, and the core are made of a composite resin material capable of transmitting the X-ray, the core is made of PET foam, and the first reinforcing panel and the second reinforcing panel are made of CFRP.

19. The X-ray detector of claim 17, further comprising:
a rim reinforcing part disposed on the same plane as the core so as to surround the core,
wherein the rim reinforcing part is disposed between the first reinforcing panel and the second reinforcing panel.

20. The X-ray detector of claim 17, wherein the spacer is made of EPP.
